(19) United States
(12) Patent Application Publication
(10) Pub. No.: US 2024/0355194 A1
(43) Pub. Date: Oct. 24, 2024

(54) OPTIMAL ENTITY CONNECTIVITY FOR TAILORED VEHICLE-TO-EVERYTHING NETWORK

(71) Applicant: INTERNATIONAL BUSINESS MACHINES CORPORATION, ARMONK, NY (US)

(72) Inventors: John M. Ganci, JR., Raleigh, NC (US); Sarbajit K. Rakshit, Kolkata (IN); Martin G. Keen, Cary, NC (US); Jeremy R. Fox, Georgetown, TX (US)

(21) Appl. No.: 18/304,646

(22) Filed: Apr. 21, 2023

(51) Int. Cl. G08G 1/01

(52) U.S. Cl. CPC G08G 1/0116; G08G 1/0129; G08G 1/0141

(57) ABSTRACT

An embodiment for connecting a vehicle to entities to form a tailored vehicle-to-everything (V2X) network is provided. The embodiment may include receiving real-time and historical data from one or more sources and an opt-in from a primary vehicle and one or more secondary vehicles. The embodiment may also include identifying one or more entity types that influenced a historical driving decision. The embodiment may further include identifying a contextual situation of one or more roadways in a geographical area. The embodiment may also include deriving one or more required entities for the primary vehicle to implement a driving decision on at least one roadway of the one or more roadways during a specific time period. The embodiment may further include creating a tailored V2X network for the primary vehicle. The embodiment may also include causing the primary vehicle to implement the driving decision.

### BACKGROUND

The present invention relates generally to the field of computing, and more particularly to a system for connecting a vehicle to entities to form a tailored vehicle-to-everything (V2X) network.

In any city, there may be different types of roads and crossings for vehicles. V2X is a vehicular communication system that supports the transfer of information from a vehicle to an external device that may affect or be affected by the movement of the vehicle. V2X technology may be used to improve road safety, save energy and resources, and promote traffic efficiency. For example, a vehicle may communicate with another vehicle, an external computing system, a pedestrian, and/or a traffic signal (e.g., a traffic light and/or stop sign). As technology continues to improve, the demand for V2X is expected to increase in the coming decades.

### SUMMARY

According to one embodiment, a method, computer system, and computer program product for connecting a vehicle to entities to form a tailored vehicle-to-everything (V2X) network is provided. The embodiment may include receiving real-time and historical data from one or more sources and an opt-in from a primary vehicle and one or more secondary vehicles. The embodiment may also include identifying one or more entity types that influenced a historical driving decision based on the historical data. The embodiment may further include identifying a contextual situation of one or more roadways in a geographical area based on the real-time and the historical data. The embodiment may also include deriving one or more required entities for the primary vehicle to implement a driving decision on at least one roadway of the one or more roadways during a specific time period based on the identified contextual situation and the one or more entity types that influenced the historical driving decision. The embodiment may further include creating a tailored V2X network for the primary vehicle by connecting the primary vehicle to the derived one or more required entities for the identified contextual situation. The embodiment may also include causing the primary vehicle to implement the driving decision.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary computing environment according to at least one embodiment.

FIG. 2 illustrates an operational flowchart for connecting a vehicle to entities to form a tailored vehicle-to-everything (V2X) network in a tailored V2X formation process according to at least one embodiment.

FIG. 3 is an exemplary diagram depicting an interaction between solution components of the process in FIG. 2 according to at least one embodiment.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

Embodiments of the present invention relate to the field of computing, and more particularly to a system for connecting a vehicle to entities to form a tailored vehicle-to-everything (V2X) network. The following described exemplary embodiments provide a system, method, and program product to, among other things, derive one or more required entities for a primary vehicle to implement a driving decision on at least one roadway of one or more roadways during a specific time period based on a contextual situation and entity types and, accordingly, create a tailored V2X network for the primary vehicle by connecting the primary vehicle to the one or more required entities for the identified contextual situation. Therefore, the present embodiment has the capacity to improve V2X technology by connecting a vehicle with entities required to make a driving decision and removing extraneous entities from the V2X network, thus optimizing the V2X network by reducing the volume of data and network bandwidth.

As previously described, in any city, there may be different types of roads and crossings for vehicles. V2X is a vehicular communication system that supports the transfer of information from a vehicle to an external device that may affect or be affected by the movement of the vehicle. V2X technology may be used to improve road safety, save energy and resources, and promote traffic efficiency. For example, a vehicle may communicate with another vehicle, an external computing system, a pedestrian, and/or a traffic signal (e.g., a traffic light and/or stop sign). As technology continues to improve, the demand for V2X is expected to increase in the coming decades. In any V2X network, different entities may generate different types of data, which may lead to a large volume of data based on the types of entities and the purposes the entities serve. Additionally, any V2X network may consume a large volume of network bandwidth. This problem is typically addressed by establishing a V2X network among nearby vehicles and transferring shared communications between the V2X network participants (e.g., from one vehicle to another vehicle). However, simply establishing the V2X network among nearby vehicles and transferring shared communications fails to consider the contextual importance of various entities in making driving decisions.

It may therefore be imperative to have a system in place to consider the contextual importance of various entities in making driving decisions. Thus, embodiments of the present invention may provide advantages including, but not limited to, considering the contextual importance of various entities in making driving decisions, dynamically connecting vehicles to required entities in a tailored V2X network, and reducing data volume and processing. The present invention does not require that all advantages need to be incorporated into every embodiment of the invention.

According to at least one embodiment, when vehicles are driving along one or more roadways, real-time and historical data from one or more sources and an opt-in from a primary vehicle and one or more secondary vehicles may be received in order to identify one or more entity types that influenced a historical driving decision based on the historical data. Upon identifying the one or more entity types, a contextual situation of the one or more roadways in a geographical area may be identified based on the real-time and the historical data so that one or more required entities for the primary vehicle to implement a driving decision on at least one roadway of the one or more roadways during a specific time period may be derived based on the identified contextual situation and the one or more entity types that influenced the historical driving decision. Then, a tailored V2X network for the primary vehicle may be created by connecting the primary vehicle to the derived one or more required entities for the identified contextual situation such that the primary vehicle may be caused to implement the driving decision. According to at least one embodiment, the driving decision may be to make a turn. According to at least one other embodiment, the driving decision may be to apply brakes. According to at least one further embodiment, the driving decision may be to maintain speed or accelerate.

According to at least one other embodiment, in response to determining at least one required entity is duplicated, the at least one duplicated required entity may be deduplicated by connecting the at least one duplicated required entity to only one vehicle.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The following described exemplary embodiments provide a system, method, and program product to derive one or more required entities for a primary vehicle to implement a driving decision on at least one roadway of one or more roadways during a specific time period based on a contextual situation and entity types and, accordingly, create a tailored V2X network for the primary vehicle by connecting the primary vehicle to the one or more required entities for the identified contextual situation.

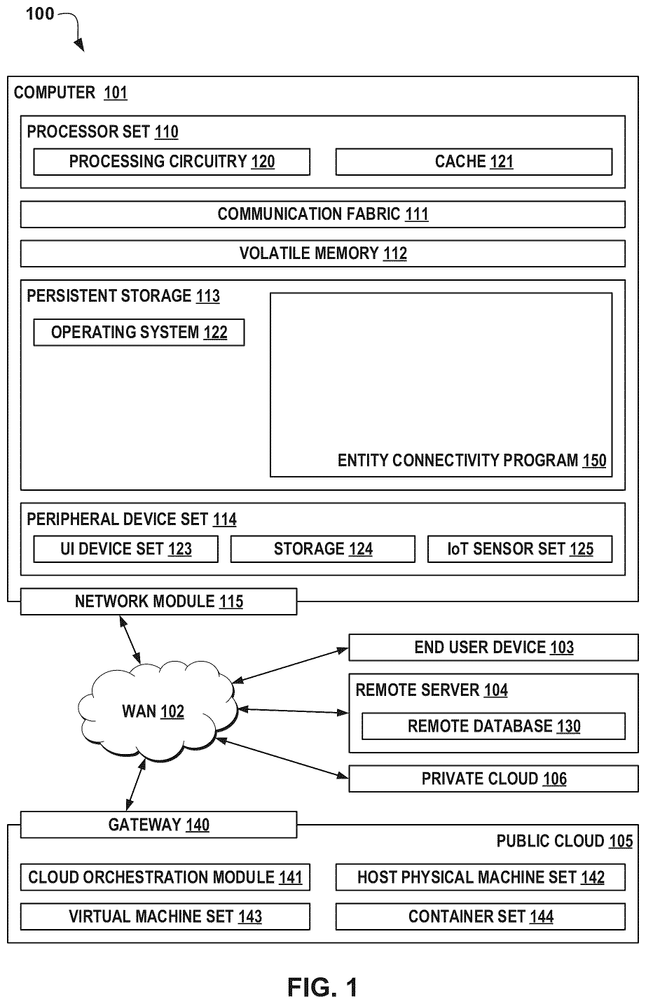

Referring to FIG. 1, an exemplary computing environment 100 is depicted, according to at least one embodiment. Computing environment 100 contains an example of an environment for the execution of at least some of the computer code involved in performing the inventive methods, such as an entity connectivity program 150. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory 112 is characterized by random access, but this is not required unless affirmatively indicated. In computer 101, the volatile memory 112 is located in a single package and is internal to computer 101, but, alternatively or additionally, the volatile memory 112 may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage 113 allows writing of data, deletion of data and re-writing of data. Some familiar forms of persistent storage 113 include magnetic disks and solid state storage devices. Operating system 122 may take several forms, such as various known proprietary operating systems or open source Portable Operating System Interface type operating systems that employ a kernel. The code included in block 150 typically includes at least some of the computer code involved in performing the inventive methods.

Peripheral device set 114 includes the set of peripheral devices of computer 101. Data communication connections between the peripheral devices 114 and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database), this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector. Peripheral device set 114 may also include a vehicle (e.g., autonomous or manually driven), a GPS device, a camera, a traffic signal (e.g., a stop sign and/or traffic light), and/or any other device capable of communicating with the vehicle.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN 102 and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments the private cloud 106 may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

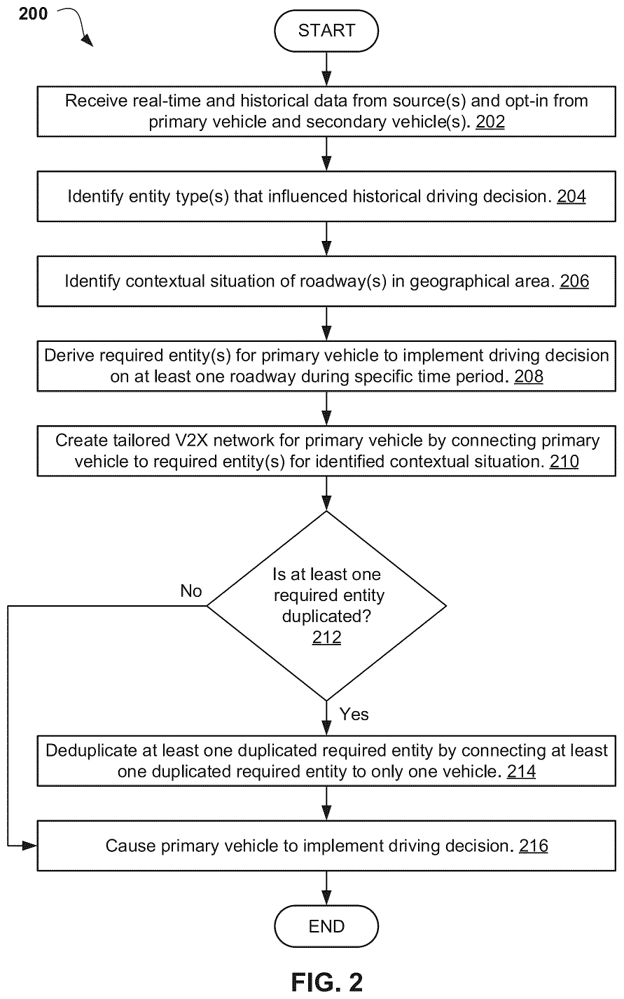

According to the present embodiment, the entity connectivity program 150 may be a program capable of receiving real-time and historical data from one or more sources and an opt-in from a primary vehicle and one or more secondary vehicles, deriving one or more required entities for a primary vehicle to implement a driving decision on at least one roadway of one or more roadways during a specific time period based on a contextual situation and entity types, creating a tailored V2X network for the primary vehicle by connecting the primary vehicle to the one or more required entities for the identified contextual situation, considering the contextual importance of various entities in making driving decisions, dynamically connecting vehicles to required entities in a tailored V2X network, and reducing data volume and processing. Furthermore, notwithstanding depiction in computer 101, the electronic map engagement program 150 may be stored in and/or executed by, individually or in any combination, end user device 103, remote server 104, public cloud 105, and private cloud 106. The entity connectivity method is explained in further detail below with respect to FIG. 2. It may be appreciated that the examples described below are not intended to be limiting, and that in embodiments of the present invention the parameters used in the examples may be different.

Referring now to FIG. 2, an operational flowchart for connecting a vehicle to entities to form a tailored vehicle-to-everything V2X network in a tailored V2X formation process 200 is depicted according to at least one embodiment. At 202, the entity connectivity program 150 receives the real-time and the historical data from the one or more sources and the opt-in from the primary vehicle and the one or more secondary vehicles. As used herein, “primary vehicle” means the vehicle for which the tailored V2X network is created, and “secondary vehicle” means any other vehicle crowdsourced to upload data to a knowledge corpus and/or a database, such as remote database 130. Examples of the source may include, but are not limited to, a vehicle (e.g., an autonomous or manually driven vehicle), a GPS device, a camera, a traffic signal (e.g., a stop sign and/or traffic light), a smartwatch or smart collar, a bicycle, and/or any other IoT device capable of communicating with the vehicle via any V2X network. The one or more sources may be located on or beside multiple roadways in a given geographical area (e.g., the Washington, D.C. metropolitan area).

The one or more sources may be utilized by the entity connectivity program 150 to capture data on the plurality of roadways. The data may include, but is not limited to, traffic conditions, roadway conditions (e.g., potholes and/or surface type), speed of vehicles traveling along the multiple roadways, weather conditions, roadway visibility, social media data, and/or time of day (e.g., rush hour or off-peak). For example, a camera and/or an autonomous vehicle may detect that a roadway has limited visibility due to a sharp curve along the roadway. In another example, the GPS device may detect that a particular roadway has more vehicle and pedestrian traffic during rush hour than during other times of the day. As described above, the data is collected in real-time and historically. The historical data may be input into and retrieved from the knowledge corpus and/or the database, such as remote database 130. In this manner, the real-time data becomes the historical data upon being input into the knowledge corpus and/or remote database 130.

The opt-in from the primary vehicle and the one or more secondary vehicles may be an agreement by the primary vehicle and the one or more secondary vehicles to upload collected data to other devices in the V2X network and/or the knowledge corpus. According to at least one embodiment, the opt-in may be provided by the owner and/or driver of the primary vehicle and the one or more secondary vehicles on behalf of the primary vehicle and the one or more secondary vehicles.

Then, at 204, the entity connectivity program 150 identifies the one or more entity types that influenced the historical driving decision. The one or more entity types are identified based on the historical data. Examples of the entity type may include, but are not limited to, a traffic control device (e.g., a stop sign and/or traffic light), a transportation device (e.g., a bicycle and/or vehicle), a navigation device (e.g., a GPS system), and/or a personal device (e.g., a smartwatch and/or smart collar). Thus, there may be at least some overlap between the one or more sources and the one or more entity types. It may be appreciated that each “entity type” as used herein is to be construed as a genus encompassing individual species. For example, for the entity type “traffic control device,” this entity type may include the species “stop sign,” “yield sign,” and/or “traffic light.”

In addition to receiving the various types of real-time and historical data, as described above with respect to step 202, the entity connectivity program 150 may also identify the volume of data and the frequency at which the data is generated by the one or more sources. The volume and frequency may be utilized by the entity connectivity program 150 to determine how much data is needed and the frequency at which that data must be sent to a particular vehicle for that particular vehicle to implement the historical driving decision. The historical driving decision may be an instance of a driving decision in the past that was implemented from a prior V2X network communication. Examples of the historical driving decision may include, but are not limited to, make a turn, apply the brakes, maintain speed and/or accelerate.

For example, in the past a vehicle may have applied the brakes to stop for a red traffic light. Continuing the example, the entity connectivity program 150 may have identified that in order for the vehicle to implement the driving decision, the traffic light may have generated five megabits (MB) of data and the data was streamed at a rate of 100 megabits per second (Mbps). In another example, a vehicle may have made a turn to change lanes in response to construction as captured from the GPS system. Continuing the example, the entity connectivity program 150 may have identified that in order for the vehicle to implement the driving decision, the GPS system may have generated 10 megabits (MB) of data and the data was streamed at a rate of 200 megabits per second (Mbps). Thus, in the examples described above, the entity types that influenced the historical driving decision may be the traffic control device and the navigation device.

Next, at 206, the entity connectivity program 150 identifies the contextual situation of the one or more roadways in the geographical area. The contextual situation is identified based on the real-time and the historical data.

As described above with respect to step 202, the data captured by the one or more sources on the plurality of roadways may include, but is not limited to, traffic conditions, roadway conditions (e.g., potholes and/or surface type), speed of vehicles traveling along the multiple roadways, weather conditions, roadway visibility, social media data, and/or time of day (e.g., rush hour or off-peak). The real-time and the historical data captured in step 202 may be parsed (i.e., divided) by the entity connectivity program 150 into data for each roadway in the geographical area. For example, with respect to step 202, the real-time and the historical data may be captured for the plurality of roadways in a given geographical area (e.g., the Washington, D.C metropolitan area).

Continuing the example, roadway “A”, roadway “B”, and roadway “C” may be the major roadways in the geographical area, and thus the one or more roadways for which the contextual situation is identified. Roadway “A” may be a recently paved roadway having heavy traffic during weekday rush hours, roadway “B” may be a non-recently paved roadway having potholes and curves which restrict the visibility ahead of a driver or autonomous vehicle. Additionally, in the past month roadway “B” may have various lane closures due to construction. Roadway “C” may be an unpaved roadway extending along a more rural or suburban part of the geographical area. Additionally, portions of roadway “C” may frequently flood during moderate to heavy rainstorms.

The identified contextual situation may be utilized by the entity connectivity program 150 to derive the contextual importance of various entities in implementing driving decisions, described in further detail below with respect to step 208.

Then, at 208, the entity connectivity program 150 derives the one or more required entities for the primary vehicle to implement the driving decision on the at least one roadway of the one or more roadways during the specific time period. The one or more required entities are derived based on the identified contextual situation and the one or more entity types that influenced the historical driving decision. As used herein, the “required entity” means an entity that is necessarily connected to the primary vehicle for the primary vehicle to implement the driving decision. For example, at an intersection controlled by a traffic signal, the primary vehicle may need to be connected to the traffic signal to determine the traffic light is yellow or red and thus apply the brakes. The at least one roadway may be any roadway the primary vehicle will use to complete the journey of the primary vehicle. For example, the at least one roadway may be roadway “A” and roadway “B.” In another example, the at least one roadway may be roadway “A,” roadway “B,” and roadway “C.” Additionally, the specific time period may be the time during which the primary vehicle is expected to complete the journey, as determined by an estimated time of arrival (ETA). In order to correlate the identified contextual situation to corresponding entity types that influenced the historical driving decision, one or more machine learning algorithms may be used.

According to at least one embodiment, a random forest algorithm may utilize an ensemble of decision trees to find associations in large datasets contained in the knowledge corpus. For example, the random forest algorithm may associate the traffic control device with the stopping of the vehicle at an intersection. In another example, the random forest algorithm may associate the personal device with the turn (e.g., swerve) of the vehicle to avoid a pedestrian in a crosswalk.

According to at least one other embodiment, an anomaly detection algorithm may extract and filter out instances that are not part of typical patterns. For example, the anomaly detection algorithm may associate a dog wearing a smart collar in the roadway blocking traffic and causing the vehicle to stop as an anomaly. In this example, the entity type (e.g., personal device) that influenced the historical driving decision (e.g., apply the brakes) may not be correlated with an identified context.

According to at least one further embodiment, a K-means clustering partitioning algorithm may group similar entities together. As described above with respect to step 204, each “entity type” as used herein is to be construed as a genus encompassing individual species. For example, for the entity type “traffic control device,” this entity type may include the species “stop sign,” “yield sign,” and/or “traffic light.” In this example, since the “stop sign,” “yield sign,” and “traffic light” regulate traffic moving through an intersection, the K-means clustering partitioning algorithm may group “stop sign,” “yield sign,” and “traffic light” together as similar entities.

According to at least one other embodiment, a support vector machine (SVM) algorithm may utilize classification and regression analysis to classify certain data. For example, the SVM algorithm may identify different types of vehicles on the roadway. Continuing the example, the types of vehicles may include, but are not limited to, a sedan, an SUV, a tractor-trailer, a motorhome, and/or a pick-up truck. Since different types of vehicles vary in ability to stop, turn, and accelerate, it may be necessary to distinguish between multiple vehicles. For example, it may take longer for a tractor-trailer to come to a complete stop after applying the brakes than a sedan.

Next, at 210, the entity connectivity program 150 creates the tailored V2X network. The tailored V2X is created by connecting the primary vehicle to the derived one or more required entities for the identified contextual situation. Utilizing the output of the algorithms described above with respect to step 208, the primary vehicle may be connected to the required entities.

For example, where the route of the primary vehicle includes travel on roadway “A” at 5:00 p.m. on a Monday, and the contextual situation of roadway “A” is that traffic is heavy and many bicycles and pedestrians are crossing the roadway, the entity connectivity program 150 may connect the primary vehicle to the one or more traffic control devices, such as a traffic signal, a stop sign, and or a yield sign, and a smartwatch of the pedestrians. In this manner, the primary vehicle may be able to drive effectively along roadway “A” without causing an accident. Contrarily, where the route of the primary vehicle includes travel on roadway “A” at midnight on a Monday when vehicle and pedestrian traffic are considerable less, the entity connectivity program 150 may only connect the primary vehicle to the traffic signal, the stop sign, and/or the yield sign. In another example, where the route of the primary vehicle includes travel on roadway “B” and the context of roadway “B” is that the roadway has potholes, curves, and ongoing construction throughout the day, the entity connectivity program 150 may connect the primary vehicle to a speed camera (e.g., to slow down in the presence of construction workers and minimize the damage from potholes) and the traffic signal, stop sign, and or yield sign. In this manner, the primary vehicle may be able to slow down when approaching a lane closure and construction vehicles. In a further example, where the route of the primary vehicle includes travel on roadway “C” and the context of roadway “C” is that the roadway is unpaved and extends along a more rural or suburban part of the geographical area with domestic animals, the entity connectivity program 150 may connect the primary vehicle to a smart collar (e.g., to slow down in the presence of dogs in yards adjacent to the roadway) and the traffic signal, stop sign, and or yield sign.

According to at least one embodiment, connecting the primary vehicle to the one or more required entities for the identified contextual situation may include continuously monitoring for changes in the identified contextual situation. The one or more required entities in the V2X network may then be altered in accordance with the updated contextual situation. Altering the one or more required entities may include adding additional entities or removing certain entities that are no longer necessary. In this manner, the tailored V2X network may be created dynamically in response to changes in the surrounding environment. For example, the original contextual situation of roadway “A” at midnight may be that there is little pedestrian and vehicle traffic. Continuing the example, the original contextual situation may change due to vehicles and pedestrians getting out of a concert or sporting event. In this example, the entity connectivity program 150 may add the smartwatches of the pedestrians back to the tailored V2X network. In another example, the original contextual situation of roadway “B” at 2:00 p.m. may be that there is ongoing construction. Continuing the example, the original contextual situation may change due to a project finishing early. In this example, the entity connectivity program 150 may remove the speed camera from the tailored V2X network, since it may no longer be necessary to slow down the primary vehicle to protect the workers or avoid potholes.

It may be desirable to connect different types of vehicles to different entities that can best support the vehicle. Thus, according to at least one other embodiment, the tailored V2X network may be created based on the types of vehicles as well as the volume of data and frequency at which the data is generated. For example, the entity connectivity program 150 may have identified that in order for the sedan to implement the historical driving decision, a required entity may need to generate 10 MB of data and stream the data at a rate of 200 Mbps. However, in order for a tractor-trailer to implement the historical driving decision, a required entity may need to generate 20 MB of data and stream the data at a rate of 400 Mbps. Thus, in this example, the entity connectivity program 150 may connect the sedan to a required entity capable of at least generating 10 MB of data and streaming the data at a rate of 200 Mbps, whereas the entity connectivity program 150 may connect the tractor-trailer to a required entity capable of at least generating 20 MB of data and streaming the data at a rate of 400 Mbps.

Then, at 212, the entity connectivity program 150 determines whether at least one required entity is duplicated. The at least one required entity is duplicated when the at least one required entity is connected to multiple co-located vehicles (i.e., vehicles within a pre-defined distance). The primary vehicle may communicate with the one or more secondary vehicles to determine whether the at least one required entity is communicating with the multiple co-located vehicles. For example, the same traffic light may be connected to the primary vehicle and at least one secondary vehicle 500 feet away from the primary vehicle.

In response to determining the at least one required entity is duplicated (step 212, “Yes” branch), the tailored V2X formation process 200 proceeds to step 214 to deduplicate the at least one duplicated required entity by connecting the at least one duplicated required entity to only one vehicle. In response to determining the at least one required entity is not duplicated (step 212, “No” branch), the tailored V2X formation process 200 proceeds to step 216 to cause the primary vehicle to implement the driving decision.

Next, at 214, the entity connectivity program 150 deduplicates the at least one duplicated required entity. The at least one duplicated required entity may be deduplicated by connecting the at least one duplicated required entity to only one vehicle. Deduplicating the at least one duplicated required entity may include disconnecting the at least one duplicated required entity from each vehicle except for the primary vehicle. The primary vehicle may then serve as an intermediary between the at least one duplicated required entity and the one or more secondary vehicles. According to at least one embodiment, in response to determining the primary vehicle is unable to maintain the connection, the at least one previously deduplicated required entity may be reconnected to exactly one secondary vehicle. For example, due to an electrical failure, the primary vehicle may be unable to maintain the connection.

Then, at 216, the entity connectivity program 150 causes the primary vehicle to implement the driving decision. Depending upon the data generated by the one or more required entities in the tailored V2X network, the primary vehicle may receive a signal to perform an action including, but not limited to, making a turn, applying the brakes, accelerating, or maintaining speed.

Causing the primary vehicle to implement the driving decision may include controlling the primary vehicle to reduce the speed of the primary vehicle in response to identifying a problem condition. According to at least one embodiment, the problem condition may be that the primary vehicle is unable to connect to at least one required entity. Due to a lack of data, mechanical failure, and/or being out of range, the primary vehicle may not be able to connect to the at least one entity. In this embodiment, the primary vehicle may be connected to a similar required entity. For example, where the primary vehicle is unable to connect to a traffic light, the primary vehicle may be connected to a stop sign, since the stop sign and traffic light fall under the entity type “traffic control device.” According to at least one other embodiment, the problem condition may be that the identified contextual situation is unable to be associated with the historical driving decision. As described above with respect to step 208, the one or more machine learning algorithms may be used to associate the identified contextual situation with corresponding entity types that influenced the historical driving decision. However, in some instances, a historical driving decision may not exist in the knowledge corpus for a specific identified context. For example, there may be no historical driving decision associated with a water main break on the roadway. In either embodiment, the entity connectivity program 150 may control the primary vehicle to reduce the speed of the primary vehicle.

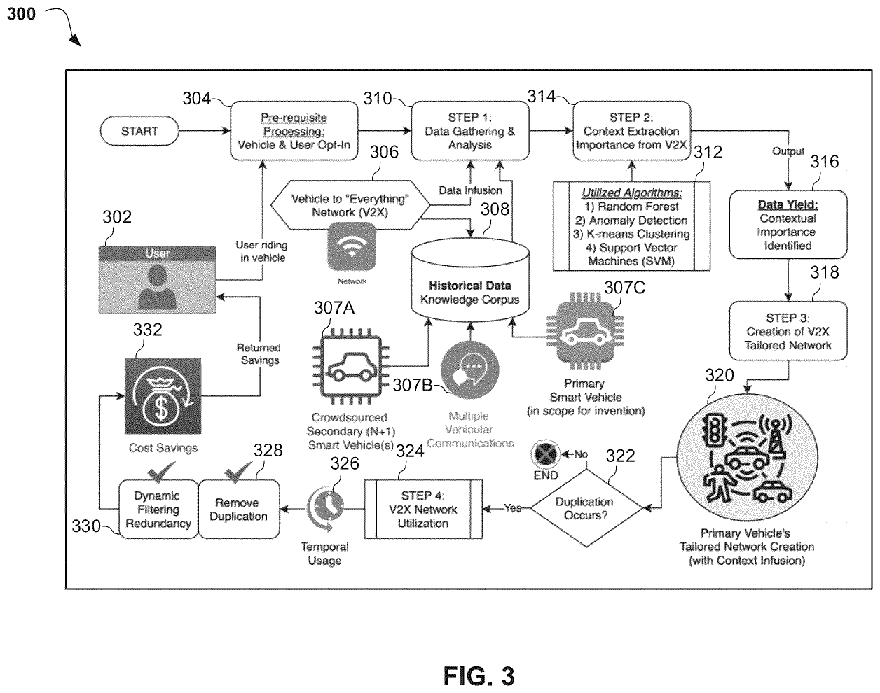

Referring now to FIG. 3, an exemplary diagram 300 depicting an interaction between solution components of the process in FIG. 2 is shown according to at least one embodiment. In the diagram 300, the user 302 opts-in to allow corresponding vehicles to collect data along the one or more roadways. A pre-requisite processing module 304 may receive the opt-in from the user 302. Devices in a V2X network 306 may upload the collected data to a knowledge corpus 308. The data collectors may include the one or more secondary vehicles 307A and the primary vehicle 307C. Multiple communications 307B from the one or more secondary vehicles 307A and the primary vehicle 307C may be uploaded into the knowledge corpus 308. A data gathering and analysis module 310 may ingest the data in the knowledge corpus 308 and a plurality of algorithms 312 may be used by a context extraction module 314 to identify the contextual importance of entities 316. The contextual importance of entities 316 may be used by a tailored V2X network module 318 to create the tailored V2X network 320 for the primary vehicle 307C. A duplication module 322 determines whether the at least one required entity is duplicated. A V2X network utilization module 324 may cause the primary vehicle 307C to implement the driving decision during the specific time period 326. In response to determining deduplication occurs, a duplication removal module 328 deduplicates the at least one duplicated required entity. Additionally, according to at least one embodiment, a dynamic filtering redundancy module 330 filters out any previously required entities that are no longer required due to a change in the identified contextual situation. By minimizing the number of entities connected to the primary vehicle 307C at any given time and thereby reducing power consumption and cloud related costs, a cost savings module 332 may return any savings to the user 302.

It may be appreciated that FIGS. 2 and 3 provide only an illustration of one implementation and do not imply any limitations with regard to how different embodiments may be implemented. Many modifications to the depicted environments may be made based on design and implementation requirements.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-based method of connecting a vehicle to entities, the method comprising:
receiving real-time and historical data from one or more sources and an opt-in from a primary vehicle and one or more secondary vehicles;
identifying one or more entity types that influenced a historical driving decision based on the historical data;
identifying a contextual situation of one or more roadways in a geographical area based on the real-time and the historical data;
deriving one or more required entities for the primary vehicle to implement a driving decision on at least one roadway of the one or more roadways during a specific time period based on the identified contextual situation and the one or more entity types that influenced the historical driving decision;
creating a tailored vehicle-to-everything (V2X) network for the primary vehicle by connecting the primary vehicle to the derived one or more required entities for the identified contextual situation; and
causing the primary vehicle to implement the driving decision.

2. The computer-based method of claim 1, further comprising:
determining whether at least one required entity is duplicated; and
in response to determining whether the at least one required entity is duplicated, deduplicating the at least one duplicated required entity by connecting the at least one duplicated required entity to only one vehicle.

3. The computer-based method of claim 2, wherein the deduplicating further comprises:
disconnecting the at least one duplicated required entity from each vehicle except for the primary vehicle, and wherein in response to determining the primary vehicle is unable to maintain the connection, reconnecting the at least one deduplicated required entity to exactly one secondary vehicle.

4. The computer-based method of claim 1, wherein connecting the primary vehicle to the one or more required entities for the identified contextual situation further comprises:
continuously monitoring for changes in the identified contextual situation and altering the one or more required entities in the V2X network in accordance with the updated contextual situation.

5. The computer-based method of claim 1, wherein causing the primary vehicle to implement the driving decision further comprises:
controlling the primary vehicle to reduce a speed of the primary vehicle in response to detecting a problem condition.

6. The computer-based method of claim 5, wherein the speed of the primary vehicle is reduced in response to determining the primary vehicle is unable to connect to at least one required entity.

7. The computer-based method of claim 5, wherein the speed of the primary vehicle is reduced in response to determining the identified contextual situation is unable to be associated with the historical driving decision.

8. A computer system, the computer system comprising:
one or more processors, one or more computer-readable memories, one or more computer-readable tangible storage medium, and program instructions stored on at least one of the one or more computer-readable tangible storage medium for execution by at least one of the one or more processors via at least one of the one or more computer-readable memories, wherein the computer system is capable of performing a method comprising:
receiving real-time and historical data from one or more sources and an opt-in from a primary vehicle and one or more secondary vehicles;
identifying one or more entity types that influenced a historical driving decision based on the historical data;
identifying a contextual situation of one or more roadways in a geographical area based on the real-time and the historical data;
deriving one or more required entities for the primary vehicle to implement a driving decision on at least one roadway of the one or more roadways during a specific time period based on the identified contextual situation and the one or more entity types that influenced the historical driving decision;
creating a tailored vehicle-to-everything (V2X) network for the primary vehicle by connecting the primary vehicle to the derived one or more required entities for the identified contextual situation; and
causing the primary vehicle to implement the driving decision.

9. The computer system of claim 8, the method further comprising:
determining whether at least one required entity is duplicated; and
in response to determining whether the at least one required entity is duplicated, deduplicating the at least one duplicated required entity by connecting the at least one duplicated required entity to only one vehicle.

10. The computer system of claim 9, wherein the deduplicating further comprises:
disconnecting the at least one duplicated required entity from each vehicle except for the primary vehicle, and wherein in response to determining the primary vehicle is unable to maintain the connection, reconnecting the at least one deduplicated required entity to exactly one secondary vehicle.

11. The computer system of claim 8, wherein connecting the primary vehicle to the one or more required entities for the identified contextual situation further comprises:
continuously monitoring for changes in the identified contextual situation and altering the one or more required entities in the V2X network in accordance with the updated contextual situation.

12. The computer system of claim 8, wherein causing the primary vehicle to implement the driving decision further comprises:
controlling the primary vehicle to reduce a speed of the primary vehicle in response to detecting a problem condition.

13. The computer system of claim 12, wherein the speed of the primary vehicle is reduced in response to determining the primary vehicle is unable to connect to at least one required entity.

14. The computer system of claim 12, wherein the speed of the primary vehicle is reduced in response to determining the identified contextual situation is unable to be associated with the historical driving decision.

15. A computer program product, the computer program product comprising:
one or more computer-readable tangible storage medium and program instructions stored on at least one of the one or more computer-readable tangible storage medium, the program instructions executable by a processor capable of performing a method, the method comprising:
receiving real-time and historical data from one or more sources and an opt-in from a primary vehicle and one or more secondary vehicles;
identifying one or more entity types that influenced a historical driving decision based on the historical data;
identifying a contextual situation of one or more roadways in a geographical area based on the real-time and the historical data;
deriving one or more required entities for the primary vehicle to implement a driving decision on at least one roadway of the one or more roadways during a specific time period based on the identified contextual situation and the one or more entity types that influenced the historical driving decision;
creating a tailored vehicle-to-everything (V2X) network for the primary vehicle by connecting the primary vehicle to the derived one or more required entities for the identified contextual situation; and
causing the primary vehicle to implement the driving decision.

16. The computer program product of claim 15, the method further comprising:
determining whether at least one required entity is duplicated; and
in response to determining whether the at least one required entity is duplicated, deduplicating the at least one duplicated required entity by connecting the at least one duplicated required entity to only one vehicle.

17. The computer program product of claim 16, wherein the deduplicating further comprises:
disconnecting the at least one duplicated required entity from each vehicle except for the primary vehicle, and wherein in response to determining the primary vehicle is unable to maintain the connection, reconnecting the at least one deduplicated required entity to exactly one secondary vehicle.

18. The computer program product of claim 15, wherein connecting the primary vehicle to the one or more required entities for the identified contextual situation further comprises:
continuously monitoring for changes in the identified contextual situation and altering the one or more required entities in the V2X network in accordance with the updated contextual situation.

19. The computer program product of claim 15, wherein causing the primary vehicle to implement the driving decision further comprises:
controlling the primary vehicle to reduce a speed of the primary vehicle in response to detecting a problem condition.

20. The computer program product of claim 19, wherein the speed of the primary vehicle is reduced in response to determining the primary vehicle is unable to connect to at least one required entity.
